(19) United States
(12) Patent Application Publication
(10) Pub. No.: US 2015/0104102 A1
(43) Pub. Date: Apr. 16, 2015

(54) SEMANTIC SEGMENTATION METHOD WITH SECOND-ORDER POOLING

(71) Applicant: Universidade de Coimbra, Coimbra (PT)

(72) Inventors: Joao CARREIRA, Alcobaca (PT); Rui CASEIRO, Coimbra (PT); Jorge BATISTA, Antanhol (PT); Cristian SMINCHISESCU, Lund (SE)

(73) Assignee: Universidade de Coimbra, Coimbra (PT)

(21) Appl. No.: 14/052,081

(22) Filed: Oct. 11, 2013

(51) Int. Cl. G06K 9/00; G06K 9/62

(52) U.S. Cl. CPC G06K 9/00624; G06K 9/6218; G06K 9/6261
USPC 382/195

(57) ABSTRACT

Feature extraction, coding and pooling, are important components on many contemporary object recognition paradigms. This method explores pooling techniques that encode the second-order statistics of local descriptors inside a region. To achieve this effect, it introduces multiplicative second-order analogues of average and max pooling that together with appropriate non-linearities that lead to exceptional performance on free-form region recognition, without any type of feature coding. Instead of coding, it was found that enriching local descriptors with additional image information leads to large performance gains, especially in conjunction with the proposed pooling methodology. Thus, second-order pooling over free-form regions produces results superior to those of the winning systems in the Pascal VOC 2011 semantic segmentation challenge, with models that are 20,000 times faster.

### TECHNICAL FIELD

The following relates to the semantic segmentation, feature pooling, producing numerical descriptors of arbitrary image regions, which allow for accurate object recognition with efficient linear classifiers and so forth.

### BACKGROUND OF THE INVENTION

Object recognition and categorization are central problems in computer vision. Many popular approaches to recognition can be seen as implementing a standard processing pipeline: dense local feature extraction, feature coding, spatial pooling of coded local features to construct a feature vector descriptor, and presenting the resulting descriptor to a classifier. Bag of words, spatial pyramids and orientation histograms can all be seen as instantiations of steps of this paradigm. The role of pooling is to produce a global description of an image region—a single descriptor that summarizes the local features inside the region and is amenable as input to a standard classifier. Most current pooling techniques compute first-order statistics. The two most common examples are average pooling and max-pooling, which compute, respectively, the average and the maximum over individual dimensions of the coded features. These methods were shown to perform well in practice when combined with appropriate coding methods. For example average-pooling is usually applied in conjunction with a hard quantization step that projects each local feature into its nearest neighbor in a codebook, in standard bag-of-words methods. Max-pooling is most popular n conjunction with sparse coding techniques.

### SUMMARY OF THE INVENTION

The present invention introduces and explores pooling methods that employ second order information captured in the form of symmetric matrices. Much of the literature on pooling and recognition has considered the problem in the setting of image classification. It pursues the more challenging problem of joint recognition and segmentation, also known as semantic segmentation.

The descriptor is obtained by aggregating local features on patches lying inside the region, capturing their second-order statistics and then passing those statistics through appropriate non-linear mappings. The technique sets no constraints on the type of image regions employed. The resulting descriptors are applicable in scenarios related to classification, clustering and retrieval of images and their constituent elements.

The problem of representing images or arbitrary free-form regions is related, but somewhat orthogonal to the one of recognizing those images (or regions) into categories, once represented. The invention brings contributions primarily to the representation of free-form regions, yet it is also demonstrated on a challenging problem of semantic segmentation (identifying and correctly classifying the spatial layout of objects in images). The most advanced, practically successful descriptors that can be used to represent general image regions are based on histograms of local features. Initially a large number of image features are extracted from a training set and grouped based on a clustering algorithm in order to identify frequently occurring patterns, also known as a code-book. For new images, features are extracted and represented with respect to the existing cluster centres (code-book), to form a histogram modelling the frequency of occurrence of different elements in the codebook.

For image classification or even more detailed region recognition, such ‘bag-of-features’ descriptors are used in conjunction with non-linear similarity metrics (kernels) as required in practice in order to achieve good performance. The recently proposed Fisher encoding is an exception, as it has obtained interesting results using only linear models, although the framework typically was applied for image classification on rectangular regions (full images) rather than arbitrary free form ones. Some of the earlier semantic segmentation methods, aiming to identify the spatial layout of objects in images, and recognize them correctly, directly classify local features, placed on a regular grid, based on information collected in their immediate neighbourhood. Therefore, they do not need to compute region descriptors, but these methods do not obtain competitive performance in realistic imagery. More successful recent methods consider regions with wider scope, beyond patches, where the expressive power and overall efficiency of the region descriptors assumes primary importance. Previously developed descriptors having a similar efficiency profile to the ones disclosed here lead to much lower recognition accuracy. Descriptors with slightly inferior accuracy than the ones here described can indeed be obtained by employing non-linear kernels, but they are computationally demanding which makes them difficult to use when processing large image databases. The Fisher encoding performance on general image regions has not been established and it is computationally expensive. It also requires codebook estimation, which is an additional step that may be slow and may require adaptation or re-computation across different datasets.

Compared to previous descriptors, instead of the first order statistics computed on codebook representations (histograms), the invention derives representations based on second-order statistics, by averaging the outer products of each local feature with itself. In order to define a descriptor comparison metric which is mathematically consistent, the outer product calculation is followed by a matrix logarithm calculation (and additionally a per-element power scaling). The final matrix is converted to a vector which is can be used with efficient linear classifiers. Extensive experiments show that applying all of these components is important and brings significant additions to accuracy.

The new descriptors work with linear classifiers, which are orders of magnitude faster than classifiers based on non-linear kernels, both during training (object model construction) and testing, and they scale to very large-scale image databases. No codebook construction is necessary (codebook construction is both computationally demanding and susceptible to local minima and model selection issues) and more powerful second-order information (correlations, as opposed to first order averages) is captured compared to existing methodology.

The inventive contributions can be summarized as comprising the following:
1. Second-order feature pooling methods leveraging recent advances in computational differential geometry. In particular take advantage of the Riemannian structure of the space of symmetric positive definite matrices to summarize sets of local features inside a free-form region, while preserving information about their pairwise correlations. The proposed pooling procedures perform well without any coding stage and in conjunction with linear classifiers, allowing for great scalability in the number of features and in the number of examples.
2. New methodologies to efficiently perform second-order pooling over a large number of regions by caching pooling outputs on shared areas of multiple overlapping free-form regions.
3. Local feature enrichment approaches to second-order pooling. Standard local descriptors, such as SIFT, are augmented with both raw image information and the relative location and scale of local features within the spatial support of the region.

The inventive pooling procedure in conjunction with linear classifiers greatly improves upon standard first order pooling approaches, in semantic segmentation experiments. Surprisingly, second-order pooling used in tandem with linear classifiers outperforms first order pooling used in conjunction with non-linear kernel classifiers. In fact, an implementation of the methods described in this invention outperforms all previous methods on the Pascal VOC 2011 semantic segmentation dataset using a simple inference procedure and offers training and testing times that are orders of magnitude smaller than the best performing methods. Our method also outperforms other recognition architectures using a single descriptor on Caltech101 (this approach is not segmentation-based).

The techniques described are of wide interest due to their efficiency, simplicity and performance, as evidenced on the PASCAL VOC dataset, one the most challenging in visual recognition. The source code implementing these techniques is now available.

Many techniques for recognition based on local features exist. Some methods search for a subset of local features that best matches object parts, either within generative or discriminative frameworks. These techniques are very powerful, but their computational complexity increases rapidly as the number of object parts increases. Other approaches use classifiers working directly on the multiple local features, by defining appropriate non-linear set kernels. Such techniques however do not scale well with the number of training examples.

Currently, there is significant interest in methods that summarize the features inside a region, by using a combination of feature encoding and pooling techniques. These methods can scale well in the number of local features, and by using linear classifiers; they also have a favorable scaling in the number of training examples. While most pooling techniques compute first-order statistics, as discussed in the previous section, certain second-order statistics have also been proposed for recognition. For example, covariance matrices of low-level cues have been used with boosting.

Different types of second-order statistics are pursued, more related to those used in first-order pooling. The innovation focuses on features that are somewhat higher level (e.g. SIFT) and popular for object categorization, and use a different tangent space projection. The Fisher encoding also uses second-order statistics for recognition, but differently, as the new method does not use codebooks and has no unsupervised learning stage: raw local feature descriptors are pooled directly in a process that considers each pooling region in isolation (the distribution of all local descriptors is therefore not modeled).

Recently there has been renewed interest in recognition using segments, for the problem of semantic segmentation. However, little is known about which features and pooling methods perform best on such free-form shapes. Most papers propose a custom combination of bag-of-words and HOG descriptors, features popularized in other domains—image classification and sliding-window detection. At the moment, there is also no explicit comparison at the level of feature extraction, as often authors focus on the final semantic segmentation results, which depend on many other factors, such as the inference procedures.

For further reference, the following patents/publications are referenced, and each of the followings is incorporated herein by reference in its entirety: Perronin, Sanches and Mensink, U.S. Pub. No. 2012/0045134 A1, published Feb. 23, 2012 and titled “Large Scale Image Classification”; Shotton, J., Winn, J., Rother, C., and Criminisi, A.: Textonboost for Image Understanding: Mult-class Object Recognition and Segmentation by Jointly Modeling Texture, Layout, and Context. International Journal of Computer Vision, 2009; Carreira, J., Li, F. and Sminchisescu, C.: Object Recognition by Sequential Figure—Ground Ranking. International Journal of Computer Vision, 2012; Arbelaez, P., Hariharan, B., Gu, C., Gupta, S., Bourdev, L. and Malik, J.: Semantic segmentation using regions and parts. IEEE Computer Vision and Pattern Recognition, 2012; Perronnin, F., Sanchez, J. and Mensink, T.: Improving the Fisher kernel for large-scale image classification. European Conference on Computer Vision, 2010; Ladicky, L., Russel, C., Kohli, P. and Torr, P.: Associative Hierarchical CRFs for Object Class Image Segmentation. International Conference on Computer Vision, 2009; Boix, X., Gonfaus, J. M., Van de Weijer, J., Bagdanov, A. D., Serrat, J. and Gonzalez, J.: Harmony Potentials: Fusing Global and Local Scale for Semantic Image Segmentation, International Journal of Computer Vision, 2012.

The following sets forth improved methods and apparatuses that constitute the invention.

### BRIEF DESCRIPTION OF THE DRAWINGS AND TABLES

For a more complete understanding of the present invention and the advantages thereof, reference in now made to the following description and the accompanying drawings and tables, in which:

FIG. 1 plots examples of semantic segmentations including failures. There are typical recognition problems: false positive detections such as the tv/monitor in the kitchen scene, and false negatives like the undetected cat. In some cases objects are correctly recognized but not very accurately segmented, as visible in the potted plant example.

In addition, several tables relevant to the invention are incorporated in the present description, including the following.

TABLE 1 shows the average classification accuracy using different pooling operations on raw local features (e.g. without a coding stage). The experiment was performed using the ground truth object regions of 20 categories from the Pascal VOC2011 Segmentation validation set, after training on the training set. The second value in each cell shows the results on less precise super pixel-based reconstructions of the ground truth regions. Columns 1MaxP and 1AvgP show results for first-order max and average-pooling, respectively. Column 2MaxP shows results for second-order max-pooling and the last two columns show results for second-order average-pooling. Second-order pooling outperforms first-order pooling significantly with raw local feature descriptors. Results suggest that log(2AvgP) performs best and the enriched SIFT features lead to large performance gains over basic SIFT. The advantage of 2AvgP over 2MaxP is amplified by the logarithm mapping, inapplicable with max.

TABLE 2 shows the average classification accuracy of ground truth regions in the VOC2011 validation set, using a feature combination here denoted by O2P, consisting of 4 global region descriptors, eSIFT-F, eSIFT-G, eMSIFT-F and eLBP-F. It compares with the features used by the state-of-the-art semantic segmentation method SVR-SEGM, with both a linear classifier and their proposed non-linear exponentiated-χ2 kernels. The feature combination within a linear SVM outperforms the SVR-SEGM feature combination in both cases. Columns 3-5 show results obtained when removing each descriptor from our full combination. The most important appears to be eMSIFT-F, then the pair eSIFT-F/G while eLBP-F contributes less.

TABLE 3 shows the efficiency of regressors compared to those of the best performing semantic segmentation method SVR-SEGM on the Pascal VOC 2011 Segmentation Challenge. There is training and testing on the large VOC dataset orders of magnitude faster than semantic segmentation method SVR-SEGM because linear support vector regressors are used, while semantic segmentation method SVR-SEGM requires non-linear (exponentiated-χ2) kernels. While learning is 130 times faster with the proposed methodology, the comparative advantage in prediction time per image is particularly striking: more than 20,000 times quicker. This is understandable, since a linear predictor computes a single inner product per category and segment, as opposed to the 10,000 kernel evaluations in semantic segmentation method SVR-SEGM, one for each support vector. The timings reflect an experimental setting where an average of 150 (CPMC) segments, are extracted per image.

TABLE 4 shows the semantic segmentation results on the VOC 2011 test set. The proposed methodology, O2P in the table, compares favorably to the 2011 challenge co-winners (BONN-FGT and BONN-SVR) while being significantly faster to train and test, due to the use of linear models instead of non-linear kernel-based models. It is the most accurate method on 13 classes, as well as on average. While all methods are trained on the same set of images, the novel method (O2P) and BERKELEY use additional external ground truth segmentations provided in, which corresponds to comp6. The other results were obtained by participants in comp5 of the VOC2011 challenge. See the main text for additional details.

TABLE 5 shows the accuracy on Caltech101 using a single feature and 30 training examples per class, for various methods. Regions/segments are not used in this experiment. Instead, as typical for this dataset (SPM, LLC, EMK), there is a pool over a fixed spatial pyramid with 3 levels (1×1, 2×2 and 4×4 regular image partitionings). Results are presented based on SIFT and its augmented version eSIFT, which contains 15 additional dimensions.

### DETAILED DESCRIPTION OF EMBODIMENTS

### Second-Order Pooling

First, a collection of m local features D=(X, F, S) is assumed, characterized by descriptors X=(x1, . . . , xm), xεRⁿ, extracted over square patches centered at general image locations F=(f1, . . . , fm), fεR², with pixel width S=(si, . . . , sm), sεN. Furthermore, a set of k image regions R=(R1, . . . , Rk) is provided (e.g. obtained using bottom-up segmentation), each composed of a set of pixel coordinates. A local feature di is inside a region Rj whenever fiεRj. Then FRj={f|fεRj} and |FRj| is the number of local features inside Rj.

Local features are then pooled to form global region descriptors P=(p1, . . . , pk), pεRq, using second-order analogues of the most common first-order pooling operators. In particular, a focus is on multiplicative second-order interactions (e.g. outer products), together with either the average or the max operators. Second-order average-pooling (2AvgP) is defined as the matrix:

$$Gavg ( Rj ) = \frac{1}{\vert FRj \vert} {\sum }_{i Fi ! Rj )} {x}_{i} \cdot {x}_{i}^{T} , \qquad ( 1 )$$

and second-order max-pooling (2MaxP), where the max operation is performed over corresponding elements in the matrices resulting from the outer products of local descriptors, as the matrix:

Gmax(Rj)=maxxᵢ·xᵢ^{T}. (2)
i:(fiεRj)

The path pursued is not to make such classifiers more powerful by employing a kernel, but instead to pass the pooled second-order statistics through non-linearities that make them amenable to be compared using standard inner products.

### Log-Euclidean Tangent Space Mapping

Linear classifiers such as support vector machines (SVM) optimize the geometric (Euclidean) margin between a separating hyperplane and sets of positive and negative examples. However Gavg leads to symmetric positive definite (SPD) matrices which have a natural geometry: they form a Riemannian manifold, a non-Euclidean space. Fortunately, it is possible to map this type of data to an Euclidean tangent space while preserving the intrinsic geometric relationships as defined on the manifold, under strong theoretical guarantees. One operator that stands out as particularly efficient uses the recently proposed theory of Log-Euclidean metrics to map SPD matrices to the tangent space at Id (identity matrix). This operator is used, which requires only one principal matrix logarithm operation per region Rj:

G_{avg}^{log}(Rj)=log(Gavg(Rj)), (3)

The logarithm using the very stable (this is the default algorithm for matrix logarithm computation in MATLAB) Schur-Parlett algorithm is computed, which involves between n³ and n⁴ operations depending on the distribution of eigenvalues of the input matrices.

Computation times of less than 0.01 seconds per region were observed in experiments. This transformation is not appllied with Gmax, which is not SPD in general.

### Power Normalization

Linear classifiers have been observed to match well with non-sparse features. The power normalization, introduced by Perronnin reduces sparsity by increasing small feature values and it also saturates high feature values. It consists of a simple rescaling of each individual feature value p by sign(p)·|p|^{h}, with h between 0 and 1. It was found that h=0.75 to work well in practice and used that value throughout the experiments. This normalization is applied after the tangent space mapping with Gavg and directly with Gmax. The final global region descriptor vector pj is formed by concatenating the elements of the upper triangle of G(Rj) (since it is symmetric). The dimensionality q of pj is therefor

$$\frac{{n}^{2} + n}{2} .$$

In practice global region descriptors obtained by pooling raw local descriptors have in the order of 10.000 dimensions.

### Local Feature Enrichment

Unlike with first-order pooling methods, good performance is observed by using second-order pooling directly on raw local descriptors such as SIFT (e.g. without any coding). This may be due to the fact that, with this type of pooling, information between all interacting pairs of descriptor dimensions is preserved. Instead of coding, the local descriptors are enriched with their relative coordinates within regions, as well as with additional raw image information. Here lies another contribution. Let the width of the bounding box of region Rj be denoted by wj, its height by hj and the coordinates of its upper left corner be [bjx, bjy]. Then the position of di is encoded within Rj by the 4 dimensional vector

$$[ \frac{fix - bjx}{wj} , \frac{fix - bjx}{hj} , \frac{fiy - bjx}{wj} , \frac{fiy - bjy}{hj} ] .$$

Similarly, a 2 dimensional feature is defined that encodes the relative scale of di within Rj: β.

$$[ \frac{{s}_{i}}{{w}_{j}} , \frac{{s}_{j}}{{w}_{j}} ] ,$$

where β is a normalization factor that makes the values range roughly between 0 and 1. Each descriptor xi is augmented with RGB, HSV and LAB color values of the pixel at fi=[fix, fiy] scaled to the range [0, 1], for a total of 9 extra dimensions.

### Multiple Local Descriptors

In practice three different local descriptors are used: SIFT, a variation which called masked SIFT (MSIFT) and local binary patterns (LBP), to generate four different global region descriptors. The enriched SIFT local descriptors are pooled over the foreground of each region (eSIFT-F) and separately over the background (eSIFT-G). The normalized coordinates used with eSIFT-G are computed with respect to the full-image coordinate frame, making them independent of the regions, which is more efficient as will be shown above. Enriched LBP and MSIFT features are pooled over the foreground of the regions (eLBP-F and eMSIFT-F). The eMSIFT-F feature is computed by setting the pixel intensities in the background of the region to 0, and compressing the foreground intensity range between 50 and 255. In this way background clutter is suppressed and black objects can still have contrast along the region boundary. For efficiency reasons, the image around the region bounding box may be cropped and the region resized so that its width is 75 pixels. In total the enriched SIFT descriptors have 143 dimensions, while the adopted local LBP descriptors have 58 dimensions before and 73 dimensions after the enrichment procedure just described.

### Efficient Pooling Over Free-Form Regions

If the putative object regions are constrained to certain shapes (e.g. rectangles with the same dimensions, as used in sliding window methods), recognition can sometimes be performed efficiently. Depending on the details of each recognition architecture (e.g. the type of feature extraction), techniques such as convolution, integral images, or branch and bound allow to search over thousands of regions quickly, under certain modeling assumptions. When the set of regions R is unstructured, these techniques no longer apply. Here, there are two ways to speed up the pooling of local features over multiple overlapping free-form regions. The elements of local descriptors that depend on the spatial extent of regions must be computed independently for each region Rj, so it will prove useful to define the decomposition x=[x^{ri}, x^{rd}] where x^{ri} represents those elements of x that depend only on image information, and x^{rd} represents those that also depend on Rj. The speed-up will apply only for pooling x^{ri}, the remaining ones must still be pooled exhaustively.

### Caching Over Region Intersections

Pooling naively using dense local feature extraction and feature coding would require the computation of k·Σⱼ|F_{R}_{ⱼ}| outer products and sum/max operations. In order to reduce the number of these operations, a two-level hierarchical strategy is introduced. The general idea is to cache intermediate results obtained in areas of the image that are shared by multiple regions. This idea is implemented in two steps. First, the regions in R are reconstructed by sets of fine-grained super pixels. Then each region Rj will require as many sum/max operations as the number of super pixels it is composed of, which can be orders of magnitude smaller than the number of local features contained inside it. The number of outer products also becomes independent of k. Regions can be approximately reconstructed as sets of super pixels by simply selecting, for each region, those super pixels that have a minimum fraction of area inside it. Several algorithms can be used to generate super pixels, including k-means, greedy merging of region intersections, all available in our public implementation. Thresholds were adjusted to produce around 500 super pixels, a level of granularity leading to minimal distortion of R, obtained in our experiments by CPMC, with any of the algorithms.

### Favorable Region Complements

Average pooling allows for one more speedup by using Σᵢxᵢ^{ri}, the sum over the whole image, and by taking advantage of favorable region complements. Given each region Rj, determine whether there are more super pixels inside or outside Rj. Sum inside Rj if there are fewer super pixels inside, or sum outside Rj and subtract from the precomputed sum over the whole image, if there are fewer super pixels outside Rj. This additional speed-up has a noticeable impact for pooling over very large portions of the image, typical in feature eSIFT-G (defined on the background of bottom-up segments).

The last step is to assemble the pooled region-dependent and independent components. For example, for the proposed second-order variant of max-pooling, the desired matrix is formed as:

$$G max ( Rj ) = [ \begin{matrix}{M}_{i}^{ri} & max {x}_{i}^{ri} \cdot {( {x}_{i}^{rd} )}^{T} \\ max {x}_{i}^{ri} \cdot {( {x}_{i}^{rd} )}^{T} & max {x}_{i}^{rd} \cdot {( {x}_{i}^{rd} )}^{T}\end{matrix} ] , \qquad ( 4 )$$

where max is performed again over i: (fiεRj) and mᵢ^{ri} denotes the sub matrix obtained using the speed-up. The average-pooling case is handled similarly. The proposed method is general and applies to both first and second-order pooling. It has however more impact in second-order pooling, which involves costlier matrix operations.

Note that when xᵣᵢ is the dominant chunk of the full descriptor x, as in the eSIFT-F described above where 96% of the elements (137 out of 143) are region independent, as well as for eSIFT-G where all elements are region-independent, the speed-up can be considerable. Differently, with eMSIFT-F all elements are region-dependent because of the masking process.

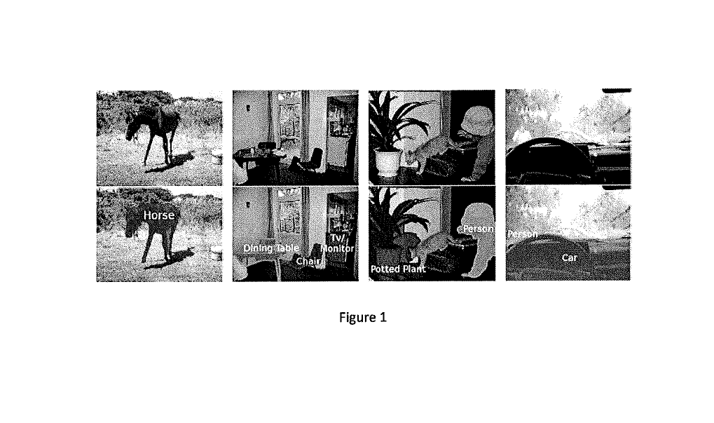

Some experimental results are shown in tables 1, 2, 3 and in FIG. 1. Several aspects of the methodology may be analyzed on the clean ground truth object regions of the Pascal VOC 2011 segmentation dataset. This allows isolation of pure recognition effects from segment selection and inference problems and is easy to compare with in future work. Recognition accuracy is also assessed in the presence of segmentation “noise”, by performing recognition on super pixel-based reconstructions of ground truth regions. Local feature extraction was performed densely and at multiple scales, using the publicly available package VLFEAT and all results involving linear classifiers were obtained with power normalization on. A beginning is with a comparison of first and second-order max and average pooling using SIFT and enriched SIFT descriptors. One-vs-all SVM models are trained for the 20 Pascal classes using LIBLINEAR, on the training set, optimize the C parameter independently for every case, and test on the validation set. Table 1 shows large gains of second-order average-pooling based on the Log-Euclidean mapping. The matrices presented to the matrix log operation have sometimes poor conditioning and a small constant may be added on their diagonal (0.001 in all experiments) for numerical stability. Max-pooling performs worse but still improves over first-order pooling. The power normalization improves accuracy by 1.5% with log(2AvgP) on ground truth regions and by 2.5% on their superpixel approximations, while the 15 additional dimensions of eSIFT help very significantly in all cases, with the 9 color values and the 6 normalized coordinate values contributing roughly the same. As a baseline, the popular HOG feature may be tried with an 8×8 grid of cells adapted to the region aspect ratio, and this achieved (41.79/33.34) accuracy.

TABLE 1

| | 1MaxP | 1AvgP | 2MaxP | 2AvgP | log(2AvgP) |
|---|---|---|---|---|---|
| SIFT | 16.61/12.36 | 33.92/25.41 | 38.74/30.21 | 48.74/39.26 | 54.17/47.25 |
| eSIFT | 26.00/18.97 | 43.33/31.91 | 50.16/40.50 | 54.30/48.35 | 63.83/56.03 |

Given the superiority of log(2AvgP), the remaining experiments will explore this type of pooling. The combination of the proposed global region descriptors eSIFT-F, eSIFT-G, eMSIFT-F and eLBP-F are evaluated and instantiated using log(2AvgP). The contribution of the multiple global regions descriptors is balanced by normalizing each one to have L2 norm 1. It is shown in table 2 that this fusion method, referred to by O2P (as in order 2 pooling), in conjunction with a linear classifier outperforms the feature combination used by SVR-SEGM, the highest-scoring system of the VOC2011 Segmentation Challenge. This system uses 4 bag-of-word descriptors and 3 variations of HOG (all obtained using first-order pooling) and relies for some of its performance on exponentiated-χ2 kernels that are computationally expensive during training and testing. The computational cost of both methods is evaluated below.

TABLE 2

| | O₂P | -eSIFT | -eMSIFT | -eLBP | Feats. in [18] | |
|---|---|---|---|---|---|---|
| | (linear) | (linear) | (linear) | (linear) | (linear) | (non-linear) |
| Accu- | 72.98 | 69.18 | 67.04 | 72.48 | 57.44 | 65.99 |
| racy | | | | | | |

In order to fully evaluate recognition performance a best pooling method was experimented on the Pascal VOC 2011 Segmentation dataset without ground truth masks. A feed-forward architecture was followed, similar to that of SVR-SEGM. First, a pool of up to 150 top-ranked object segmentation candidates was computed for each image, using the publicly available implementation of Constrained Parametric Min-Cuts (CPMC). Then, on each candidate extraction was performed for the feature combination detailed previously and these were fed to linear support vector regressors (SVR) for each category. The regressors are trained to predict the highest overlap between each segment and the objects from each category.

All 12,031 available training images were used in the “Segmentation” and “Main” data subsets for learning, as allowed by the challenge rules, and the additional segmentation annotations available online, similarly to recent experiments by Arbelaez. Considering the CPMC segments for all those images results in a grand total of around 1.78 million segment descriptors, the CPMC descriptor set. Additionally the descriptors corresponding to ground truth and mirrored ground truth segments were collected, as well as those CPMC segments that best overlap with each ground truth object segmentation to form a “positive” descriptor set. Dimensionality of the descriptor combination was reduced from 33,800 dimensions to 12,500 using non-centered PCA, then the descriptors of the CPMC set were divided into 4 chunks which individually fit on the 32 GB of available RAM memory. Non-centered PCA outperformed standard PCA noticeably (about 2% higher VOC segmentation score given a same number of target dimensions), which suggests that the relative average magnitudes of the different dimensions are informative and should not be factored out through mean subtraction. The PCA basis on the reduced set of ground truth segments plus their mirrored versions (59,000 examples) was learned in just about 20 minutes.

A learning approach similar to those used in object detection was pursued, where the training data also rarely fits into main memory. An initial model for each category using the “positive” set and the first chunk of the CPMC descriptor set was trained. All descriptors from the CPMC set that became support vectors were stored and the learned model used to quickly sift through the next CPMC descriptor chunk while collecting hard examples (outside the SVR E-margin). Then, the model using the positive set together with the cache of hard negative examples was retrained and iterated until all chunks had been processed. The training of a new model was warm-started by reusing the previous a parameters of all previous examples and initializing the values of a, for the new examples to zero. A 1.5-4× speed-up was observed.

Using 150 segments per image, the highly shape-dependent eMSIFT-F descriptor took 2 seconds per image to compute. The proposed speed-ups on the other 3 region descriptors were evaluated, where they are applicable. Naive pooling from scratch over each different region took 11.6 seconds per image. Caching reduces computational time to just 3 seconds and taking advantage of favorable segment complements reduces time further to 2.4 seconds, a 4.8× speed-up over naive pooling. The timings reported in this subsection were obtained on a desktop PC with 32 GB of RAM and an i7-3.20 GHz CPU with 6 cores.

A simple inference procedure is applied to compute labelings biased to have relatively few objects. It operates by sequentially selecting the segment and class with highest score above a “background” threshold. This threshold is linearly increased every time a new segment is selected so that a larger scoring margin is required for each new segment. The selected segments are then “pasted” onto the image in the order of their scores, so that higher scoring segments are overlaid on top of those with lower scores. The initial threshold is set automatically so that the average number of selected segments per image equals the average number of objects per image on the training set, which is around 2.2, and the linear increment was set to 0.02. The focus of this invention is not on inference but on feature extraction and simple linear classification. More sophisticated inference procedures could be plugged in.

The results on the test set are reported in table 4. The proposed methodology obtains mean score 47.6, a 10% and 15% improvement over the two winning methods of the 2011 Challenge, which both used the same nonlinear regressors, but had access to only 2,223 ground truth segmentations and to bounding boxes in the remaining 9,808 images during training. In contrast, the present models used segmentation masks for all training images. Besides the higher recognition performance, our models are considerably faster to train and test, as shown in a side-by-side comparison in Table 3. The reported learning time of the proposed method includes PCA computation and feature projection (but not feature extraction, similarly in both cases). After learning, the learned weight vector is projected to the original space, so that at test time no costly projections are required. Reprojecting the learned weight vector does not change recognition accuracy at all.

Semantic segmentation is an important problem, but it is also interesting to evaluate second-order pooling more broadly. Caltech101 is used for this purpose, because despite its limitations compared to Pascal VOC, it has been an important test bed for coding and pooling techniques so far. Most of the literature on local feature extraction, coding and pooling has reported results on Caltech101. Many approaches use max or average-pooling on a spatial pyramid together with a particular feature coding method. Here, the raw SIFT descriptors (e.g. no coding) are used and a proposed second-order average pooling on a spatial pyramid. The resulting image descriptor is somewhat high dimensional (173.376 dimensions using SIFT), due to the concatenation of the global descriptors of each cell in the spatial pyramid, but because linear classifiers are used and the number of training examples is small, learning takes only a few seconds. SVM also may be used with an RBF-kernel but with less improvement over the linear kernel. The present pooling leads to the best accuracy among aggregation methods with a single feature, using 30 training examples and the standard evaluation protocol. It is also competitive with other top-performing, but significantly slower alternatives. This new method is very simple to implement, efficient, scalable and requires no coding stage. The results and additional details can be found in table 5.

TABLE 3

| | Feature Extr. | Prediction | Learning |
|---|---|---|---|
| Exp-x² [18] (7 descript.) | 7.8 s/img. | 87 s/img. | 59 h/class |
| O₂P (4 descript.) | 4.4 s/img. | 0.004 s/img. | 26 m/class |

Here presented is a framework for second-order pooling over free-form regions and applied it in object category recognition and semantic segmentation. The proposed pooling procedures are extremely simple to implement, involve few parameters and obtain high recognition performance in conjunction with linear classifiers and without any encoding stage, working on just raw features. Here also presented are methods for local descriptor enrichment that lead to increased performance, at only a small increase in the global region descriptor dimensionality, and proposed a technique to speed-up pooling over arbitrary free-form regions. Experimental results suggest that our methodology outperforms the state-of-the-art on the Pascal VOC 2011 semantic segmentation dataset, using regressors that are 4 orders of magnitude faster than those of the most accurate methods. State-of-the-art results are obtained on Caltech101 using a single descriptor and without any feature encoding, by directly pooling raw SIFT descriptors. In the future, different types of symmetric pairwise feature interactions beyond multiplicative ones, such as max and min, are possible. Source code implementing the techniques presented in this paper recently were made publicly available online.

TABLE 4

| | O₂P | BERKELEY | BONN-FGT | BONN-SVR | BROOKES | NUS-C | NUS-S |
|---|---|---|---|---|---|---|---|
| background | 85.4 | 83.4 | 83.4 | 84.9 | 79.4 | 77.2 | 70.8 |
| aeroplane | 69.7 | 46.8 | 81.7 | 84.3 | 36.6 | 40.8 | 41.5 |
| bicycle | 22.3 | 18.9 | 23.7 | 23.9 | 18.6 | 19.9 | 20.2 |
| bird | 45.2 | 36.6 | 46.0 | 39.5 | 9.2 | 28.4 | 30.4 |
| boat | 44.4 | 31.2 | 33.9 | 35.3 | 11.0 | 27.8 | 29.1 |
| bottle | 46.9 | 42.7 | 49.4 | 42.6 | 29.8 | 40.7 | 47.4 |
| bus | 66.7 | 57.3 | 66.2 | 65.4 | 59.0 | 56.4 | 61.2 |
| car | 57.8 | 47.4 | 86.2 | 83.5 | 50.3 | 48.0 | 47.7 |
| cat | 56.2 | 44.1 | 41.7 | 46.1 | 25.5 | 33.1 | 35.0 |
| chair | 13.5 | 8.1 | 10.4 | 15.9 | 11.8 | 7.2 | 8.8 |
| cow | 48.1 | 39.4 | 41.9 | 47.4 | 29.0 | 37.4 | 38.3 |
| diningtable | 32.3 | 36.1 | 29.5 | 30.1 | 24.8 | 17.4 | 14.5 |
| dog | 41.2 | 36.3 | 24.4 | 33.9 | 16.0 | 26.8 | 28.6 |
| horse | 59.1 | 49.5 | 49.1 | 48.8 | 29.1 | 33.7 | 36.5 |
| motorbike | 55.3 | 48.2 | 50.5 | 54.4 | 47.9 | 46.6 | 47.8 |
| person | 51.0 | 50.7 | 39.6 | 46.4 | 41.9 | 40.6 | 42.8 |
| pottedplant | 36.2 | 26.3 | 19.9 | 28.8 | 16.1 | 23.3 | 28.5 |
| sheep | 50.4 | 47.2 | 44.9 | 51.3 | 34.0 | 33.4 | 37.8 |
| sofa | 27.8 | 22.1 | 26.1 | 26.2 | 11.6 | 23.9 | 26.4 |
| train | 46.9 | 42.0 | 40.0 | 44.9 | 43.3 | 41.2 | 43.5 |
| tv/monitor | 44.6 | 43.2 | 41.6 | 37.2 | 31.7 | 38.6 | 45.8 |
| Mean | 47.6 | 40.8 | 41.4 | 43.3 | 31.3 | 35.1 | 37.7 |

TABLE 5

| Aggregation-based methods | | | | | | Other | |
|---|---|---|---|---|---|---|---|
| SIFT-O₂P | eSIFT-O₂P | SPM [3] | LLC [36] | EMK [37] | MP [6] | NBNN [38] | GMK [39] |
| 79.2 | 80.8 | 64.4 | 73.4 | 74.5 | 77.3 | 73.0 | 80.3 |

The foregoing description of the preferred embodiment of the invention has been present for purposes of illustration and description. It is not intended to de exhaustive or to limit the invention to the precise form disclosed, and modifications and variations are possible in light of the above teachings or may de acquire from practice of the invention. The embodiment was chosen and described in order to explain the principles of the invention and its practical application to enable one skilled in the art to utilize the invention in various embodiments as are suited to the particular use contemplated. It is intended that the scope of the invention de defined by the claims appended hereto, and their equivalents. The entirety of each of the aforementioned documents is incorporated by reference herein.

What is claimed is:

1. A method for second-order pooling, comprising the steps of:
in a scheme where:
is assume a collection of m local features D=(X, F, S), where descriptors X is represented as a vector with m entries, extracted over square patches centered at general image locations F, where F is a vector with m entries, with pixel width S, where S is a vector with m entries;
is provided a set of k image regions R, where R is a vector with k entries, each composed of a set of pixel coordinates;
a local feature dᵢ is inside a region Rⱼ whenever fᵢεRⱼ, then F_{Rj}={f|fεRⱼ} and |F_{Rj}| is the number of local features inside R_{J};
pool local features to form global region descriptors, using second-order analogues of the most common first-order pooling operators;
focus on multiplicative second-order interactions, together with either the average or the max operators;
define second-order average-pooling (2AvgP) and second-order max-pooling (2MaxP), where the max operation is performed over corresponding elements in the matrices resulting from the outer products of local descriptors;
log-euclidean tangent space mapping, defining only one principal matrix logarithm operation per region Rj and computing the logarithm using the very stable Schur-Parlett algorithm; and
power normalization, rescaling of each individual feature value p, forming the final global region descriptor vector and concatenating the elements of the upper triangle.

2. The method as set forth in claim 1, further comprising:
enrichment the local descriptors with their relative coordinates within regions;
encoding the position of d within Rⱼ;
defining a two dimensional feature that encodes the relative scale of dᵢ;
augmenting each descriptor.

3. The method as set in claim 2, further comprising:
generating four different global region descriptors using three different local descriptors: SIFT, a variation called masked SIFT (MSIFT) and local binary patterns (LBP);
pooling the enriched SIFT local descriptors over the foreground of each region and separately over the background;
computing the normalized coordinates used with background with respect to the full-image coordinate frame;
pooling enriched LBP and MSIFT features over the foreground of the region;
setting the pixel intensities in the background of the region to 0;
compressing the foreground intensity range between 50 and 255;
suppressed background clutter;
crop the image around the region bounding box; and
resize the region so that its width is 75 pixels.

4. The method as set in claim 1, further comprising:
computing independently the elements of local descriptors that depend on the spatial extent of regions for each region Rj;
reconstructing the regions in R by sets of fine-grained super pixels;
selecting, for each region, those super pixels that have a minimum fraction of area inside it;
adjusting thresholds to produce around 500 super pixels.

5. The method as set in claim 4, further comprising:
summing inside Rⱼ if there are fewer super pixels inside, or summing outside Rⱼ and subtracting from the precomputed sum over the whole image, if there are fewer super pixels outside Rⱼ;
assembling the pooled region-dependent and independent components.
